(19) United States
(12) Patent Application Publication
(10) Pub. No.: US 2006/0248014 A1
(43) Pub. Date: Nov. 2, 2006

(54) Method and system for scheduling tracking, adjudicating appointments and claims in a health services environmentand broadcasters

(76) Inventor: Robert S. Belzer, Crystal, MN (US)

Correspondence Address: NORTH OAKS PATENT AGENCY, 45 ISLAND ROAD, NORTH OAKS, MN, 55127, US

(21) Appl. No.: 11/412,376

(22) Filed: Apr. 27, 2006

Related U.S. Application Data
(60) Provisional application No. 60/675,507, filed on Apr. 27, 2005.

(51) Int. Cl. G06Q 99/00

(52) U.S. Cl. 705/51

(57) ABSTRACT

A system and related tools is disclosed for adding metadata to media and transferring the media through secure ftp servers for eventual playback in an over-the-air broadcast, multicasting or downloading of material content to any number of devices using any number of networks for transmission of content. This content may also be manipulated for specific audience, location, Point Casting, or Geo Targeting. In addition, a system is disclosed for integrating a plurality of media service computer systems for real or near-real-time reporting of information.

### FIELD OF THE INVENTION

The present invention relates to direct media systems. More particularly, the present invention relates to a system and related tools for adding metadata to media and transferring the media through secure ftp servers for eventual playback in an over-the-air broadcast, multicasting or downloading of material content to any number of devices using any number of networks for transmission of content.

### BACKGROUND OF THE INVENTION

A digital economy came about when society began to place a value on information, products and services being offered in a timely manner. We are now only beginning to identify what economy means as a matter of life style, fact, and bottom line in real time for consumer or business consumption on demand.

The transformation of sharing information using the Internet to the paradigm shift of old media converging with the World Wide Web (WWW) as an infrastructure tool has created numerous new opportunities for business and job creation to grow. Examples of these new businesses are multimedia services, media storage, streaming, syndication, delivery, transcoding, graphic overlaying, tracking, and billing services. These multimedia services allow many publishers, product and content owners, content syndication, distributors, to store large banks of digital media provide real time, video, and audio streams to a variety of networked hardware devices and deliver and enable a variety of functions to serve and manage multimedia systems for consumption.

The digital economy is driven by the benefits of e-Business, automation, and total resource reduction and or involving the Internet as a businesses nucleus that allows the processes to speed up. Companies that begin to take advantage of scale and reduction of costs through the use of technology and the newly creation of separate businesses that are converged to increase productivity and become fully integrated digital media businesses providing a multiple number of activities will win.

The round of layoffs from the initial burst of investment in technology driven companies came from not only an economic slow down, but also as a need to prove out business models, and technology uses while showing a profit as reality of cash flow set in among investors. A next round of layoffs is coming as these newly minted businesses converge with each other to meet the demand that businesses is going to move from currently being judged by the quarter to by the moment, and financial reporting becomes real time decision-making interest. The addition of MPEG 21 Standards, ISAN, and Ad-ID allows directing and reporting to become measurable across a plurality of networks and devices. We must allow companies to adjust and adapt to the use of technology before making final decisions on the overall valuation of these corporations. The proof of business models utilizing new technology advancements is going to determine valuation with market acceptance and penetration. The personality and executive management becomes increasingly critical as the interaction with the consumer becomes more available and ON-DEMAND through the use of the Internet but yet is still going to be relationship driven as access to combined software and hardware solutions become a commodity.

The digital revolution is advancing the consumer by providing access to niche products and services. Young and affluent families are growing up with multiple ways to communicate, entertain, and learn. Baby boomers are connecting to the Internet to make travel plans, monitor investments, and INTERACT with personal hobbies and interests with in an instant and they are making decisions in real time. The less fortunate individuals or family's that do not have enough financial resources are going to find technology as a hindrance of privacy as its used to track and measure and only those who have the ability to excel and rise above the crowd will be able to move to an improved lifestyle, however there is always the old fashioned way of marriage as away to foster an immediate impact on lifestyle.

Providing what the consumer wants and when they want it is going to be a factor in the overall success. Companies will need to decide what, how, and why they invest in developing content and providing consumable goods or services with an issue of having multiple companies involved in each transaction. The convergence of enabling technologies to a single source is going to become most valuable. When the new generations of devices that access content begin to penetrate the viewing audience, and savvy Internet users begin using more than one device for interactive communications, the opportunity to generate more commerce becomes a multi-channel sales approach. The being able to aggregate, syndicate, distribute, manage, track, report, measure, and facilitate transactions on multiple number of networks and or devices with an ability to provide a return on actual investment and produce a profit for both consumption and distribution a true partnership return on investment takes effect. The Effective loss leaders that will entice new costumers and or provide customer relationship management will prove favorable and add value to the overall branding of product, service, and experiences becoming more important to meeting consumer needs and values.

The emerging content growth markets for consumer consumption devices and advancements in technology to stimulate interaction like iTV, using game consoles, STB, mobile devices, and PC's will forever change the interpersonal communication patterns of these users. The revenue from ON-DEMAND content will not be enough for access providers to survive financially as these profits will be shared in many directions. Highly targeted e-commerce solutions will begin to rely more on emotional and precision types of marketing to maximize buyer interaction. This interaction is going to depend on the way content is accessed. The cost for this type of marketing is going to be expensive at first but will decrease overtime as life long brands are developed and loss leaders for distribution of content are developed and the costs associated with providing advanced technology to consumers for content access is established for life long relationships. The broadcasters and ISP's are going to be sensitive to pricing concerns as it pertains to value associated to the service. Companies that choose to work with full service firms will look to leverage multiple brands across multiple networks to stimulate and find full value of the overall relationship.

We now enter an aging population and less young to support and try new things reaching early adopters is going to become more crucial to the overall success of launching new products and services. Those that combine lifestyle with brand and a higher level of service that is satisfactory to society while the Internet becomes pervasive to everyday living will benefit significantly. The access and content providers will rule in the digital age. The companies that can supply a multiple number of sales and distribution channels will win. The idea! Development and use of brand and image is everything. Rich Media Rules and renting a brand becomes possible through strategic partnerships or Co-Branding to leverage costs and network distribution. A corporation that is empowered by the financial and capital markets will enable the growth potential of that particular company. This growth will be dynamic as pricing adjusts to market demands on a global basis in real time following MPEG 21 and the use of ISAN and Ad-ID standards.

The standards committees and governing bodies that have large associations and membership support will provide consumers a level of immediate trust but the overall experience with product or service is going to determine success.

Executions of new products or services will have less time to prove themselves, as digital market places will have a built in audience operating around the clock in all areas of the world. The ability to view and become comfortable with products and services is going to become more important, as emotional and precision marketing begins. The value of a relationship will increase as networks begin to cross all lines of business. Content distribution and syndication becomes more critical as competition comes in all shapes and sizes. Strategic partnership and alliances will become more meaningful as the ability to share resources and information in real time.

The influencing factors in content are going to be viewer relevance and method of delivery and association with contextually matching with the proper experiences. Company networks will thrive with new founded relationships and execution strategies that are niche focused and yet still far reaching. The on-demand content will drive e-commerce as it takes advantage of new revenue models and networks. The companies that move first can take a tier one advantage in content syndication, distribution and aggregation, working with both old media worlds and the premium Internet world wide websites and appropriate technologies and services associated with the needs. Highly targeted niche content has value and needs to be treated as an asset and all of its value will be extrapolated from storage to how consumed and on what devices as a way to measure overall effective returns on relationship management. The valuation models will replicate traditional Hollywood business models but in hyper drive for reporting following paid programming performance and logistic models.

Developing content will become more challenging for companies as they begin to evaluate selling their content upstream to cable and network providers. New technologies and integration to improve workflow combined with entrepreneurial minds will find positions being created within corporations to take advantage of new business models and relationships. Broadband Business is here today and will begin to influence consumer television content, and internet growth leads to new avenues of access and types of content or products being offered. The use of direct response or infomercials about company products begin to appear on corporate websites and personal emotional testimonials that can relate to the active audience so consumers can relate to the overall experience and performance. The desire to capture profits and generate commerce based transactions and being able to take advantage of lower cost structures will drive companies to find ways to syndicate their products and services through a multiple number of connected devices. This will also relate to general media and www.secpath.com will help people track and measure their media placement on various devices and networks.

Creating content is going to become more strategic as companies' needs begin to evolve as will it processes. In order for a company to succeed on the outside, it must realize maximum value on the inside with people, tools, technology, and communication. The Internet is a machine that is used to increase operating process and system integration. Connecting with the end user is the key to success. E-Learning is going to evolve as both a traditional and online experience for the end user and internal organization in the corporate environment as the paradigm shift begins to take place and being able to effectively measure and track results and be able to make immediate changes as necessary. E-Learning software application is how converged communication will morph interaction into individual user experiences with highly measurable outcomes based upon relevancy and accurate usage of information. The content that will be created will be in the form of AdUtainment, BizUtainment, EdUtainment, infotainment, interactive entertainment, and virtual entertainment These choices are going to make ON-DEMAND content and streaming media become the mainstay and a PERVASIVE INTERNET will be the enabler. Broadcast television, live entertainment, and first run movies will continue to be the premium content offered. However, changes in the form of delivery, transmission, and reception will be influenced from technology growth and adoption from all parties—from where and how content is received—comes at a high expense as disparate technologies, that are not integrated or an approved standard will become increasingly volatile to the success of the owner. Making an advanced investment will be at risk but not making one will be even riskier.

A company to become successful in today's economy needs to start catering to the young and developing a relationship that will evolve with them. This audience will influence the higher wage earning audiences. The baby boomers are current bread and butter, but the gravy is targeting the kids with early adaptive educational toys, game consuls, and technologies will lead to the growth of iTV. The baby boomer crowd is going to become informed and more interactive through important influences in their life and effective use of rich media for financial, health, travel, and hobbies will lead to new revenue sources and providing all consumers with AdUtainment. E-Learning, edutainment, will influence niche e-commerce transaction and larger transactions will happen through PC's in the immediate future but as ondemand content becomes more accessible on mobile devices those revenues will also increase overtime. Companies are going to need to invest in many areas from people to technology and develop content that serves multiple markets, affecting a multitude of company budgets. The companies that begin this process today are going to be the real winners when broadband connects with the home user and influences personal consumption. The relationship is key and following the golden rule still applies having a trusted interpersonal relationship with end users is going to be treated like having a religion and how its viewed by the consumer.

A need exists for a system to address these and similar deficiencies associated with the current frame work of multiple devices, multiple networks, multiple formats, and multiple points of access based on a wide and micro demographic audiences and economic situations.

The present invention provides a solution to these needs and other problems, and offers other advantages over the prior art.

### BRIEF SUMMARY OF THE INVENTION

The present invention is related to a system that solves the above-mentioned problems. In accordance with one embodiment of the invention, a system and related tools is disclosed for adding metadata to media and transferring the media through secure ftp servers for eventual playback in an over-the-air broadcast, multicasting or downloading of material content to any number of devices using any number of networks for transmission of content. This content may also be manipulated for specific audience, location, Point Casting, or Geo Targeting. In addition, a system is disclosed for integrating a plurality of media service computer systems for real or near-real-time reporting of information.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 is data flow of an embodiment of the present invention transcoding schema.

FIG. 2 is a diagram showing flow of media information between various parts of the media system over the internet.

FIGS. 3-19 show a series of web browser-based user interface screens for an embodiment of the present invention implemented as a website on the Internet.

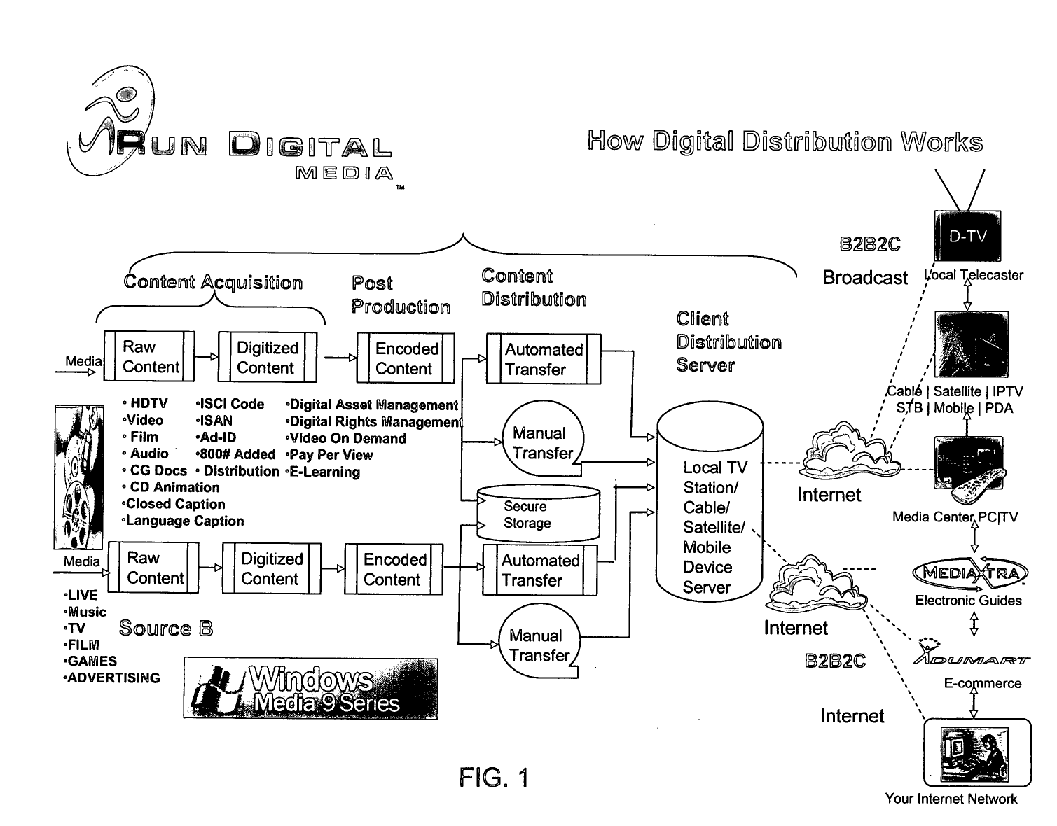

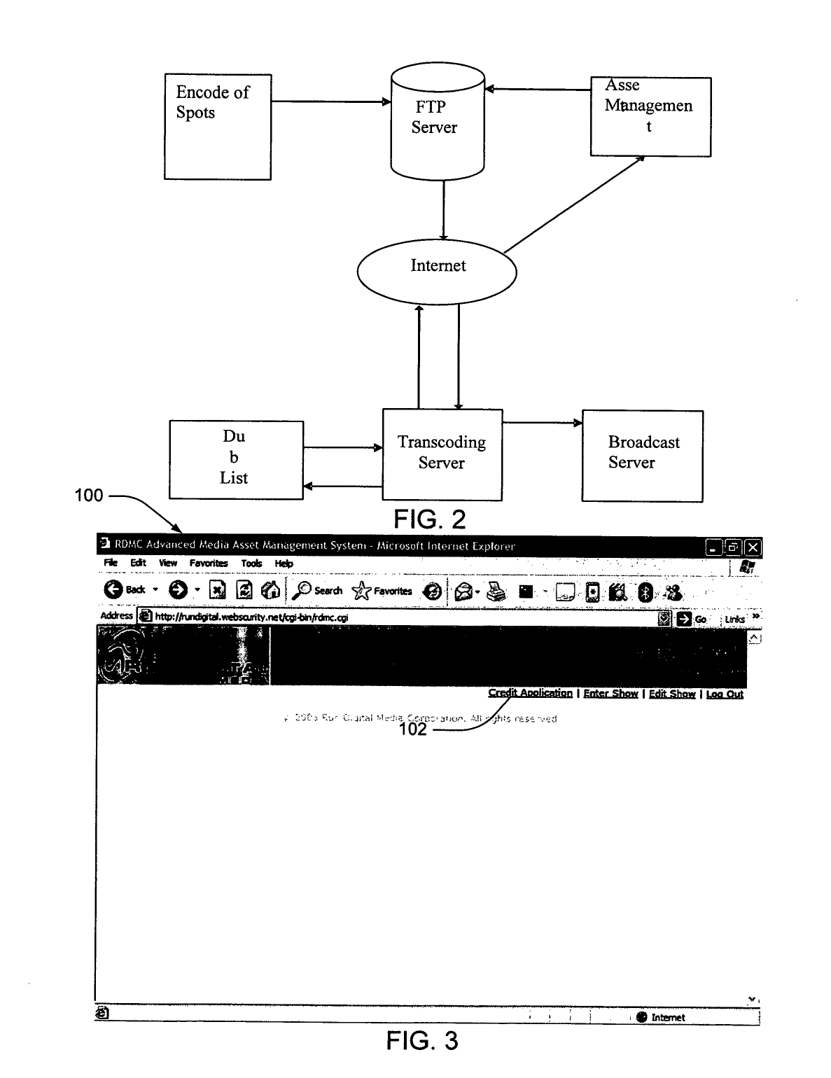

### DETAILED DESCRIPTION

The use of an 800 number or a digital watermark allows for tracking callers by the zip code, device, network, affiliation, and it also allows for reporting on who is the distributor, owner, agency, aggregator, operator, network, syndicator, and who gets paid in each transaction and at what value all the way through the entire life cycle and not limited to consumer modifications or changes in the material additional changes to the material will lead to a new measurable metric for tracking and reporting It's without a doubt the most challenging aspect of broadcast programming distribution. For example, a local broadcaster could have the same program from 4 different advertising agencies or distributors and all would have a different 800 numbers, and or watermarks that would allow for tracking the results of where a program is aired. A paid program using 800# for tracking could have 400 different 800#'s associated with single program.

An Internet-Only transport system for delivering broadcast-ready television programming is described below as the most effective use for transmission of material to a multiple number of networks and devices. This new broadcast delivery service saves thousands of dollars over traditional tape delivery or satellite delivery and VPN, or Fiber Optic transmissions

In one embodiment, delivery of half-hour infomercial programming and direct response spots, via the Internet in ready to broadcast format is described. As paid programming is the most challenging content to distribute for broadcast as it includes dedicated 800 numbers for tracking and reporting the results of each airing on a per TV DMA market basis or zip code. Digital Water Marking and or adding some other form of reporting on actual airing or play in either direction forward or backward for delivery of the message that leads to a transaction is one that is highly valuable. The transmission of the content needs to be flexible enough to reach an audience that can generate some measurable outcome on a plurality of networks and devices for both financial or relationship influencer for immediate, future benefit or gain. Having the ability to predict or measure the performance based upon overall measurement dealing with some of the issues like, File Size, length of program, richness of the media is going to become relevant when measuring overall success.

How It Works:
The content material is advanced encoded and compressed into intelligent objects in the ubiquitous Windows Media Player format or other format that is as flexible enough to reach all effective outlets of communication in any medium. (Microsoft's implementation of VC-1, the SMPTE standard), specifically for use in broadcast and is adaptable for internet distribution allowing for converged communication. Delivered in multiple files so the material can be manipulated later as its delivered in layers to the transcoding server.
Windows Media is the only acceptable format that enables the ability for both broadcast TV and Internet for distributing content to both communication mediums from a single source format.
A proprietary metadata-based system is utilized to direct, track, and report on media using secure FTP servers for transfer and downloads content onto a Microsoft Windows-based transcoding server for playback via over-the-air broadcast providing an automated workflow environment for broadcasters and allows for content consumption on internet devices.
The distribution solution keeps track of all metadata and accurately displays the use of 800 numbers and other important overlays necessary when distributing paid programming and other content for distribution over a variety of networks and devices.
An Internet proxy file with ISAN, and/or Ad-ID, is also available for monitoring and measuring the content to the traffic departments for both the broadcaster and Media Agency who manage the scheduled time, remnant time in a schedule or on demand for multiple uses. This ensures the content is correct and trackable, and replaces the use of tapes used for paid programming delivery. This file is also useable to playback on multi-devices and networks, example IPTV, mobile phones, and STB.

A topical-graphical overlay is provided for customizable media applications based upon audio and video compression algorithms and time codes of the material being encoded for distribution to multiple locations and played back in multiple devices following the values of mpeg 7 and mpeg 21 and ISCI broadcast standards. This information is valuable for 800 telephone numbers, closed caption, language translation, that are on every infomercial and DR/Spot Advertisement aired on TV and can be utilized of for general media distribution.

Note that ISCI is also an acronym for the standard “bar-coding” that appears on products sold by retail or other services designating product Information and is an approved standard for broadcasting that continues to involve with technology innovation.

The 2005 Updated Edition of the TDGA Radio-TV Glossary of Terms & Definitions defines ISCI Code as:—(Abbreviation for Industry Standard Commercial Instructions and/or International Standard Coding Identification): It is a commercial code largely used to identify specific radio and television commercials. The analog ID codes have migrated to this digital format to work with the ever-expanding electronic transmission of spots including radio, TV and e-mail. The system eliminates much of the manual trafficking of advertisements. All large advertisers are assigned an alphanumeric “ISCI” code so that each spot from an advertiser can be tracked at the station individually. You can probably just make this number up if your client is small. ISCI codes begin with 4 letters identifying your client and ends with 4 numbers pertaining to that spot. E.g., if the client's name is Anderson Brothers and it's a: 30 spot shot in 2002, you might make the ISCI code ANDB-2301. The ANDB stands for Anderson Brothers and the 2 stands for the year the spot was produced, the 3 stands for 30 spot, and 01 stands for the fact that it's their 1st spot. This is the way it's done at most ad agencies. The only difference being that a clearinghouse for large advertisers assigns the prefix.

Increased syndication and aggregation of the material is allowed and if the value is comprised in the DNA at the source of ingest allowing for consumers to access and further manipulate the media based upon layers of added digital rights management (DRM). The metadata would automatically increase by a numerical value to formulate a new serial number to base it's originality and authenticity as a new copy right.

Inside the value of mpegs 7 and 21, ISCI, Ad-ID, and ISAN broadcast standards the actual reporting process would change as ownership of the new media's originality would need to be compensated along with it's creator of the source file. This new media becomes more flexible and traceable allowing for personalization to meet the needs of its users' interest.

The reporting aspects of the material and providing access to measurable results is relevant to all interested parties who are partaking in the information for either financial or informational gain.

At the point of material ingest the basic rules are included in the metadata as a way to report, index, and traffic the media to any medium, any device, at anytime.

Turning now to the encoding operation, the filename consists of the following fields each separated by an underscore (except for the 800 number):
Show name—as it sounds and will become “Title”
Version—as it sounds will provide financial or informational value associated to all parties in the transaction
Agency of Record—as it sounds (will become “Agency” value in metadata info and owner of show will know its value

800#—Will serve as ISCI code metadata info
Sub Agency—as it sounds will provide financial or information value associated with distribution of material and can be determined by the Agency of Record or content owner.
Distribution Outlet—as it sounds is used for transmission, navigation and connection either direct or indirect through a ftp connection
Distribution Network/Media Mgmt Software—this labels which network is being utilized for transmission and payments could be made accordingly and what media management software is being utilized.
A time code is included at the end to show running time and possible scheduling used by distributor, syndicator, receiver of material and can be used as a way to index or organize the material.

An example filename I have is:

DreamLips_{—}100521_ChesapeakeMedia_{—}800_{—}709_{—}8950_APEX_Y5_RDMAMT.2 8:32.wmv

One more point that needs to be clarified is in handling file durations, leaders and trailers for the media files can be used by the distribution network to access and play, connect media with specific devices or software applications

The duration of these files needs to be known prior to delivery to the on-air server for schedule. Therefore, adding to the file format some notion of file duration would be helpful. Example when working with Florical automation system a notification about the file and its duration is needed before transcoding and delivery of the file to the target broadcast server.

Next, regarding leaders and trailers. There are two options:
Create the file without any leader or trailer. This could simply process the entire file and notify automation accordingly
Have a fixed size leader and/or trailer. Then the leaders and trailers can be trimmed when the file is transcoded and delivered to the broadcast server.

Preferably when encoding material for broadcast a 28:30 show will have an additional 1 second or fixed size leader/trailer on the front and back for on-air playback systems so every program or ad now would time code 28:32 as an example.

Information from Table one is used in the encoding process for the metadata.

TABLE 1
RUN DIGITAL MEDIA CONTENT SUBMISSION FORM

| Client: | | Zone Vision |
|---|---|---|
| Attention: | | Helen Frost |
| Address: | | 105-109 Salisbury road |
| | | London, England NW6 6RG |
| Telephone: | | 44 20 7644 7119 |
| Fax: | | 44 20 7624 3652 |
| E-mail: | | helen.frost@zonevision.com |
| Date of Submission: | | 11-Jan-05 |
| Required Date of Delivery: | | 1/13/2005 |
| Method of Delivery: | | Circle one: Disc (CD/DVD) |
| (if FTP, please provide | | or FTP WM9 |
| specific instructions) | | |
| Media Format: | | WM9 |
| Media Name/Label: | | Daily complete |
| Clip Name: | | Daily Complete |
| Agency of Record: | | Response TV Network |
| Telephone 800#: | | 476-7805 |
| Sub-Agency: | | Apex |
| Distribution: | | (please highlight) Internet |
| Time In (Run Time or Time Code): | | :60 |
| Time Out (Run Time or Time Code): | | :60 |
| Encoded Clip Name: | | Daily Complete |
| Visible | Title: | Daily Complete |
| Metadata | Author: | Response TV Network |

| | |
|---|---|
| Copyright: | 2005 |
| Description: | Entertainment |
| Rating: | Health |
| Bitrate 1: | |
| Required Pixel Size (if applicable): | |
| Bitrate 2: | |
| Required Pixel Size (if applicable): | |
| Bitrate 3: | |
| Required Pixel Size (if applicable): | |
| Bitrate 4: | |
| Required Pixel Size (if applicable): | |
| Bitrate 5: | |
| Required Pixel Size (if applicable): | |
| Special Instructions: | Email Bob Belzer |
| (codec specifics, emergency | bob@rundigital.net |
| phone #, etc.) | when finished. (Future |
| | uploading instructions |
| | will appear here) |

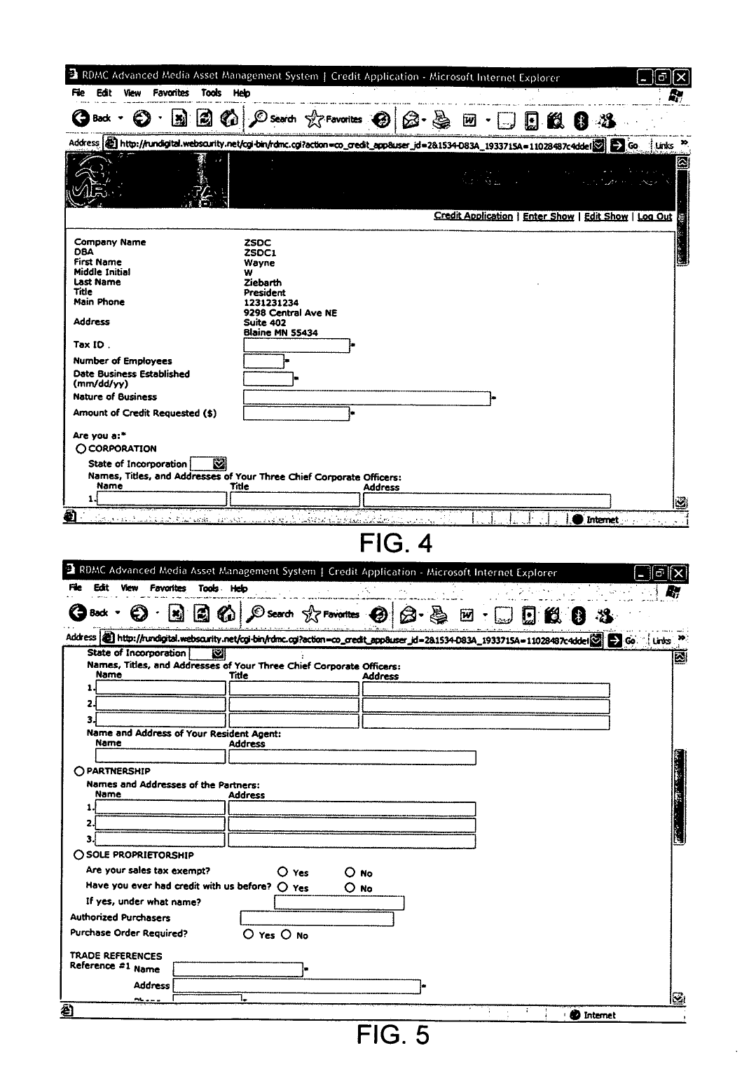

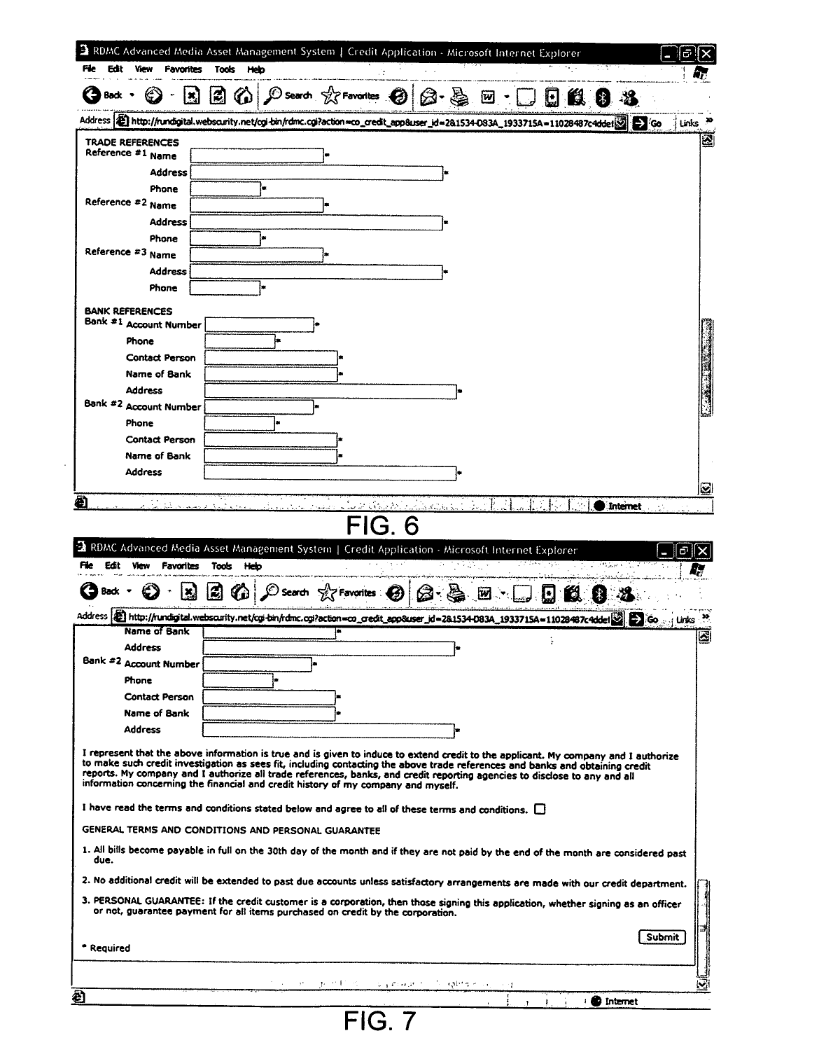

FIG. 3 is one of a series of series of web brower-based user interface screens 100 for an embodiment of the present invention implemented as a website on the Internet. Navigation among the various user interface screens is accomplished by clicking on hyperlinks such as 102 that take you to other parts of the website. When hyperlink 102 is clicked or selected, user interface screens for an online credit form as shown in FIGS. 4-7 are presented to a user. An online credit application is taken to establish an online pay in advance process which will debit a customers account once the order request is processed.

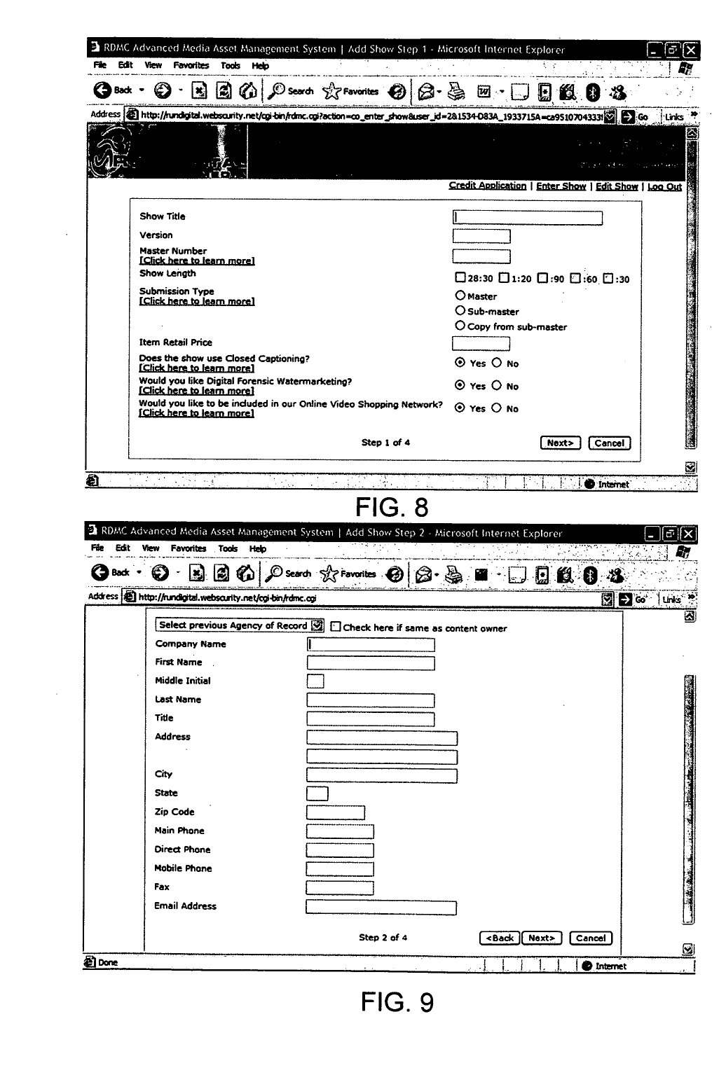

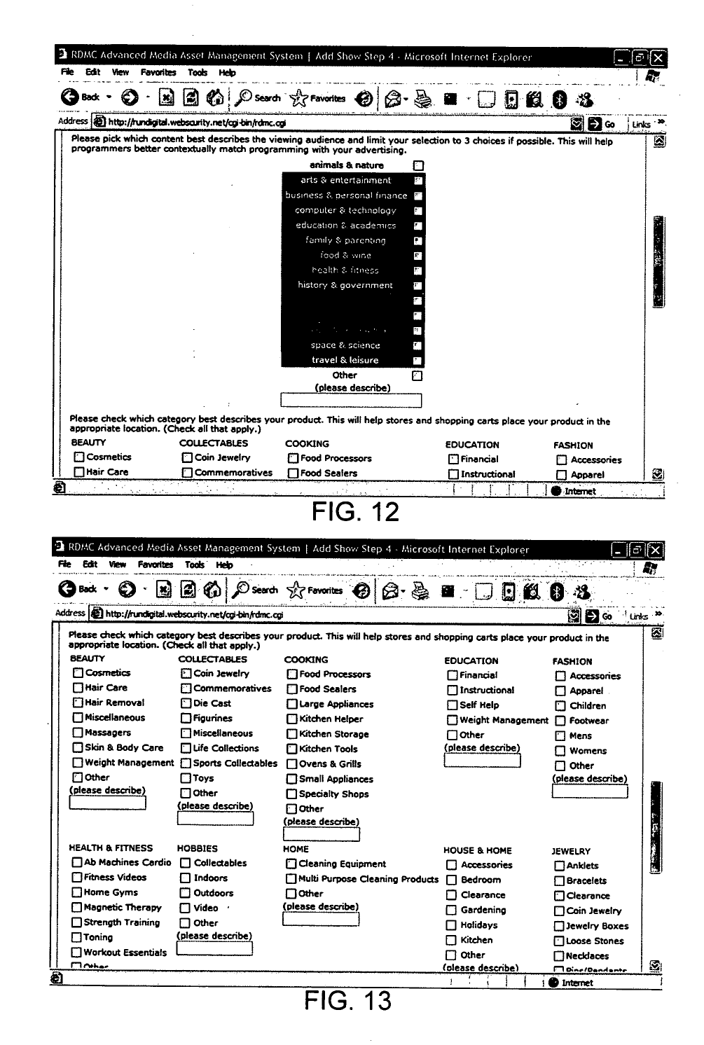

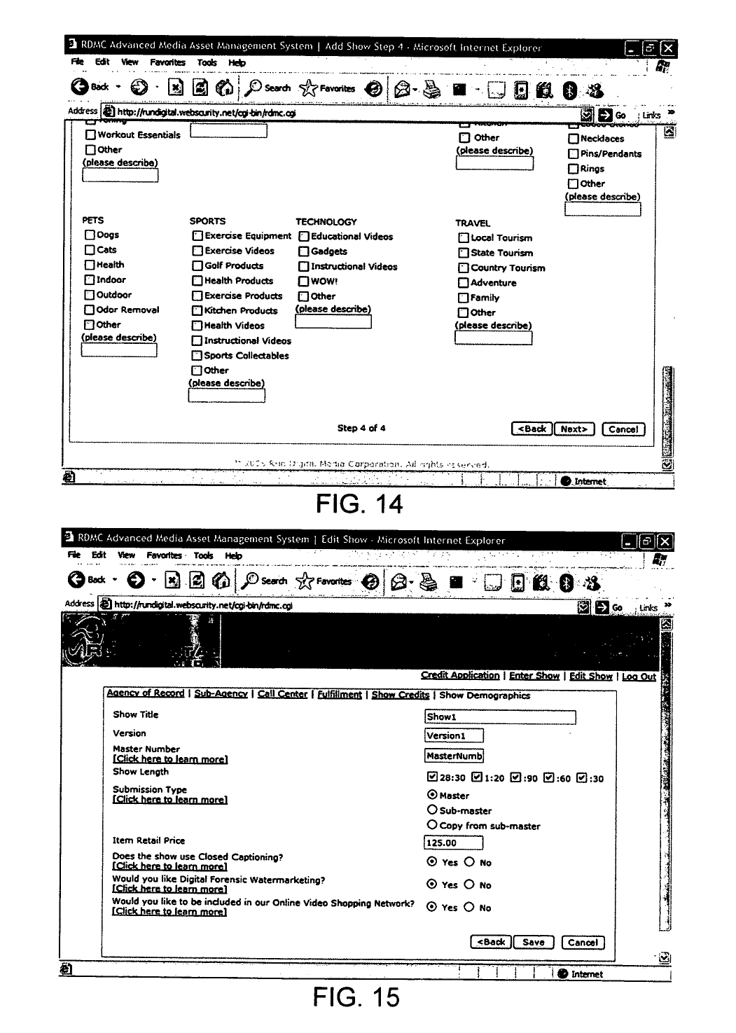

FIGS. 8 through 14 show of series of user interface screens for adding a show and metadata to the system. This slide is a screen shot where we begin to collect the metadata. This metadata includes:
Show Title is as what it means
Show Version will change with each new rendition or call to action modification
Show Length is how long the show is and it can very in lenght a Submission type informs us what file are we working from is it the original/Show's Master copy or a sub master a copy from the master. This is important as the quality can only decrease with each new copy produced.
Use of closed caption informs of what to watch for and or if we need to sell that service to the client
Digital Forensic Watermarking is a service that allows for the content owner or agency of record to track when and where the show is airing.

The importance of selecting an Agency of Record (AOR) is that is the main agency who establishes all of the sub agency's. This can also be controlled by the Content Owner. The information collected can be part of the shows metadata when used for distribution.

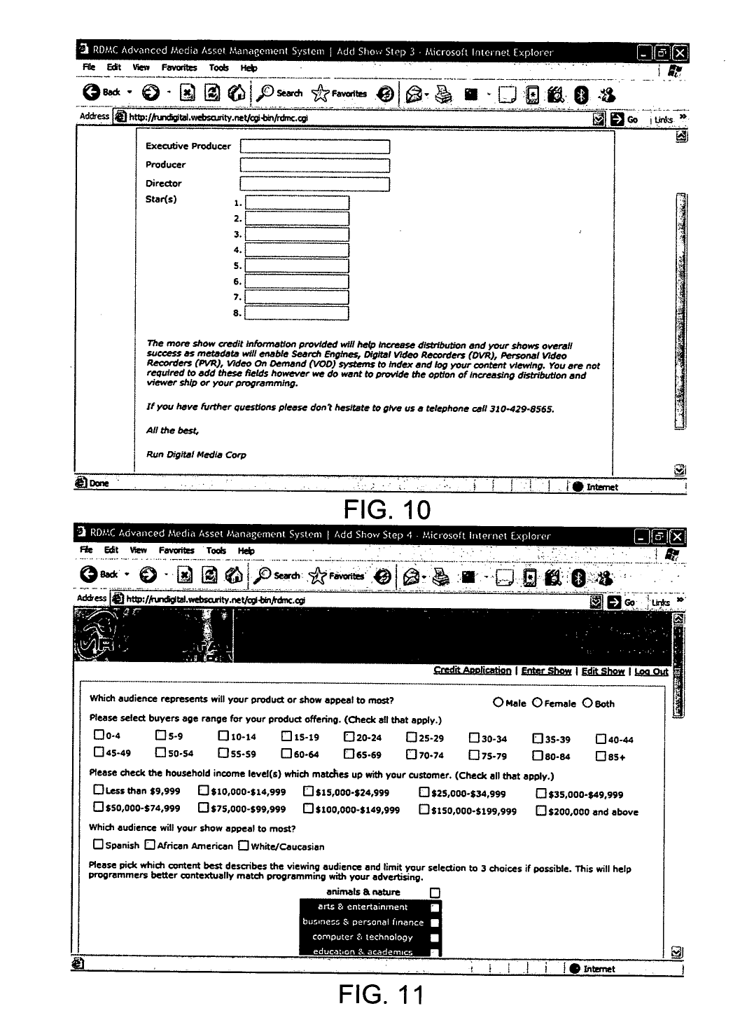

In FIG. 10, show credits are added. This information is important to include in show metadata as consumers will use Digital Video Recorders or TiVo like devices and set them to record programs based upon who's involved in them. The roles people play can very from Executive Producer, Producer, Director, and stars is all part of the credits.

In FIGS. 11 through 14, show demographics are added. The collection of specific show demographic information will enable distributors and show syndications to happen with more precision in targeting an audience. The use of color coded topics or subjects will enable programmers to schedule shows by contextually matching the content of advertisers to programs to increase performance and viewer satisfaction. Color-coding will take the guess work out of which shows/ads work well together.

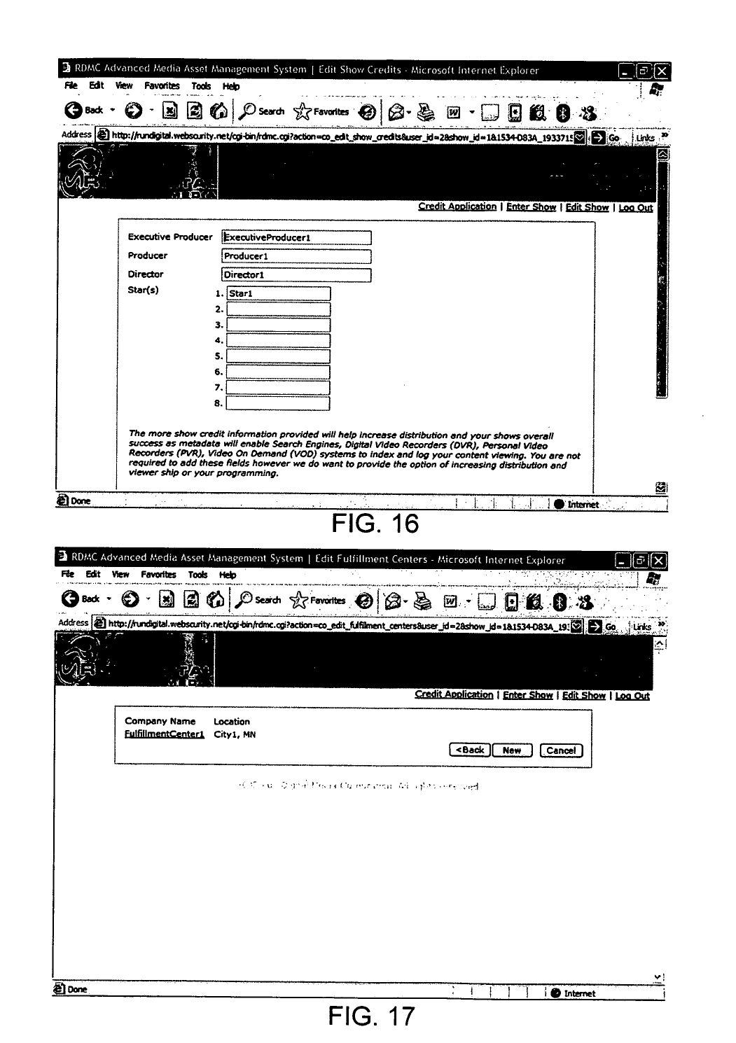

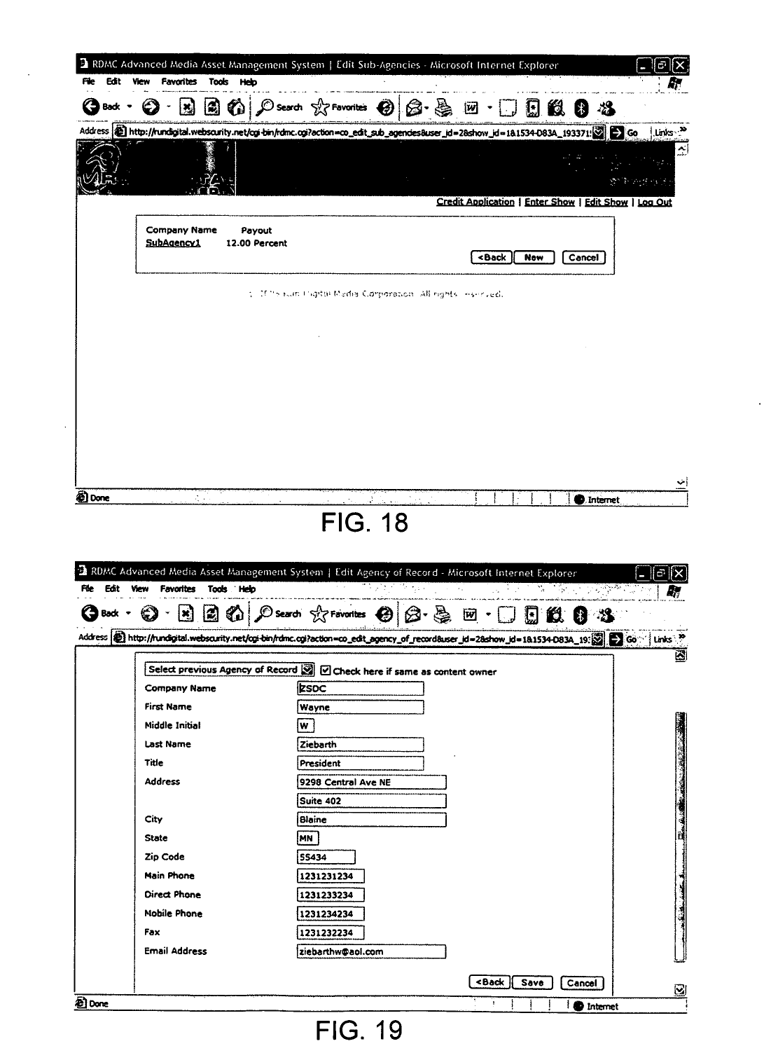

FIGS. 15 through 19 show user interface screens for editing a show. Sub Agency's who operate on a commission bases will more easily be able to track the performance of show and the financial reporting will be able to happen online with the integration of call centers and fulfillment companies who process the orders from a direct response ad.

By being able to plug in either a dollar amount of percentage of sale we will be able to calculate how much of each sale takes place and who should be paid. If an item retails for $100.00, then for example the company pays who aired the ad $50.00. The Agency might get 15% so the payout would be $42.50 to the broadcaster/distributor and the agency could be paid $7.50 for the item that was sold. If a sub agency was involved they might be working off of $42.50 and they would get 15% of that amount sold. With the $50.00 going to the show owner.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

1. A media transfer method configured for use over a network, comprising steps of:
adding metadata to media; and
transferring the media through secure ftp servers over the network to a Windows transcoding server where an image is overlaid on the media, including an 800 number for identifying a version of the media for eventual playback in an over-the-air broadcast.

2. The media transfer method of claim 1 wherein the adding step comprises adding metadata for additional tracking of media.

3. The media transfer method of claim 1 further comprising a step of multicasting or downloading the media from the Windows transcoding server to any number of devices using any number of networks for transmission.

4. The media transfer method of claim 1 wherein the version of the media is manipulated for a specific audience, location, point casting, or geo targeting.

5. The media transfer method of claim 1 further comprising a step of reporting performance and financial information real time or near real time.
